(19) United States
(12) Patent Application Publication
(10) Pub. No.: US 2019/0078881 A1
(43) Pub. Date: Mar. 14, 2019

(54) PHOTOGRAMMETRIC PANEL, PHOTOGRAMMETRY ARRANGEMENT AND PHOTOGRAMMETRY METHOD

(71) Applicant: Testo SE & Co. KGaA, Lenzkirch (DE)

(72) Inventors: Jan-Friso Evers-Senne, Titisee-Neustadt (DE); Matthias Kern, Blumberg (DE)

(73) Assignee: Testo SE & Co. KGaA, Lenzkirch (DE)

(21) Appl. No.: 16/082,403

(22) PCT Filed: Mar. 28, 2017
(86) PCT No.: PCT/EP2017/000373

§ 371 Date: Sep. 5, 2018

(30) Foreign Application Priority Data
Mar. 31, 2016 (DE) 10 2016 003 883.7

(51) Int. Cl. G01C 11/02; G01C 15/02; G06K 9/46

(52) U.S. Cl. CPC G01C 11/025; G06K 9/4604; G01C 15/02

(57) ABSTRACT

A photogrammetric panel (1) for use in a photogrammetry method, in which at least two groups (2, 4) of markings (3, 5) are printed in a crossed arrangement on a material, in particular a metal sheet (6), is provided.

The invention relates to a photogrammetric panel comprising at least two groups of markings, which are in a crossed arrangement in relation to one another. Such photogrammetric panels are known and are used to define a coordinate system in a photogrammetry method. For this purpose, the photogrammetric panel is recorded in a scene. It is possible to derive a coordinate system for the area to be sized from the image (in perspective and distorted because of the imaging direction) of the photogrammetric panel.

Moreover, it is necessary to ascertain a scaling of the respective recorded scene for the photogrammetry method. So-called scale bars are used for this purpose in the prior art. These bars have circular marks and identification features and are manufactured and calibrated with ultrahigh precision. A measurement accuracy in the range of 50 to 500 μm is achievable at typical object sizes by way of this precision.

The invention furthermore relates to a photogrammetry arrangement comprising the above-described photogrammetric panel and comprising a data processor, which is configured for photogrammetric processing of a recorded image.

Finally, the invention relates to a photogrammetry method, wherein a photogrammetric panel which has at least two crossing groups of markings is arranged in a scene, wherein at least one image is recorded of the scene, and wherein a coordinate system of the at least one recorded image is ascertained from the at least two crossing groups of markings.

The invention is based on the object of simplifying the apparatus complexity in a photogrammetry method.

According to the invention, the features of claim 1 are provided for achieving this object. In particular, it is therefore provided according to the invention, to achieve the mentioned object in the case of a photogrammetric panel of the type described at the outset, that the photogrammetric panel is manufactured from a printed material. An alternative is thus provided to the previous material selection of a panel made of carbon-fiber-reinforced plastic, which alternative is simpler to process and requires less careful handling, since the material does not become damaged and/or unusable as easily. The material preferably has a known coefficient of thermal expansion, which can be saved for a temperature compensation of an expansion of the material. Preferred materials are, for example, PVC, sandwich materials, for example made of combinations of plastic and metal plies, or—particularly preferably—metal plate.

This substantially simplifies the apparatus complexity in a photogrammetry method.

In one embodiment of the invention, it can be provided that the at least two groups of markings are applied in separate printing webs. It is advantageous in this case that a good compromise can be found between the requirements of the largest-area panel possible, on the one hand, and the requirement of a printable region that is limited to achieve a high printing accuracy. In particular, the markings can thus be applied in the printing direction with high accuracy, in order to thus also enable the derivation of a scaling from the recorded images. Alternatively or additionally, it can be provided that the at least two groups of markings are applied in a precision printing method. An individual measurement of each photogrammetric panel at the factory, which is required in the case of the above-mentioned scale bars, can thus be omitted. It is particularly favorable here if the precision printing method is executed in two printing steps, in which the two groups of markings are formed or applied separately from one another.

In one embodiment of the invention, it can be provided that the at least two groups of markings are each applied in a diagonal of a rectangular basic shape. It is advantageous in this case that a material consumption for the photogrammetric panel, which results from the dimensions of the groups of markings, can be minimized. This is particularly favorable in comparison to the previously customary alignments of the groups of markings parallel to edges of a rectangular basic shape.

In one embodiment of the invention, it can be provided that an item of identification information is applied. It is advantageous in this case that the photogrammetric panel used is automatically identifiable. This item of identification information is preferably designed so it can be read out by machine. It is particularly favorable in this case if the item of identification information is applied redundantly as a main item of identification information and a checking item of identification information. A main item of identification information can thus be made checkable. This is used to avoid reading errors, which can occur because of partially-concealed items of identification information.

It is particularly favorable in this case if the item of identification information is formed independently of the at least two groups of markings. It is advantageous in this case that the item of identification information does not have to be applied with the same precision as the two groups of markings which establish the scaling and/or the coordinate system. For example, it can be provided that the item of identification information is applied in a crossing region of the at least two groups of markings. This has the advantage that the item of identification information is displayed unconcealed in typical measuring situations.

In one embodiment of the invention, it can be provided that an item of identification information, in particular the above-mentioned item of identification information, is applied in a method separate from the application of the at least two groups of markings. An item of identification information tailored to the photogrammetric panel can thus be applied using a particularly cost-effective printing method or another method. It is therefore also possible to apply the item of identification information so it is non-removable, for example by embossing, engraving, or the like.

In one embodiment of the invention, it can be provided that a strip-shaped area on which one of the at least two groups of markings is applied is defined by material openings in a rectangular basic shape. It is advantageous in this case that an intrinsic weight of the photogrammetric panel is reducible. It is furthermore advantageous that the material openings can be used, for example, to each form a handle, at which the photogrammetric panel is portable.

In one embodiment of the invention, it can be provided that a plug region is formed on a lateral edge of the photogrammetric panel, the plug region being useable for the photogrammetric panel to be pluggable into a soft underlying surface. It is advantageous in this case that the photogrammetric panel can be aligned parallel or approximately parallel to upright surfaces in a simple manner. It is particularly favorable in this case if the plug region is formed non-printed. In this manner, items of information contained in the printing can easily be kept un-concealed during the plugging in of the photogrammetric panel. It is particularly favorable if the plug region is formed for the purpose of plugging the photogrammetric panel into a region of the earth's surface having soil. This can be achieved, for example, by a blade-like edge or by plug projections or in another manner.

In one embodiment of the invention, it can be provided that the photogrammetric panel is manufactured from printed aluminum and/or steel. It has been shown that these materials are particularly easily processable and are usable for this purpose.

The features of the coordinate claim, which is directed to a photogrammetry arrangement, are provided according to the invention for achieving the mentioned object in a photogrammetry arrangement. Therefore, it is provided according to the invention, to achieve the mentioned object in a photogrammetry arrangement of the type described at the outset, that the data processor is configured for an ascertainment of a coordinate system image from the at least two crossing groups of markings on the photogrammetric panel and for an ascertainment of an item of scaling information from the markings on the photogrammetric panel in the image. It is advantageous in this case that the previously typical separation of (large-area) panels for definition of a coordinate system, on the one hand, and (high-precision) scales for establishing an item of scaling information, on the other hand, is eliminated. Rather, the data processor is here configured, for example by corresponding programming and/or electronic conditioning in such a manner that one photogrammetric panel is sufficient for both purposes. It is particularly favorable in this case if the photogrammetric panel is designed according to the invention, in particular as described above and/or as claimed in any one of the claims directed to a photogrammetric panel.

In one embodiment of the invention, it can be provided that the data processor is configured for an extraction of at least one item of identification information on the photogrammetric panel in the at least one recorded image. The photogrammetric panel used is therefore identifiable. It is particularly favorable if the item of identification information is extractable by feature recognition. The item of identification information can thus be made, on the one hand, recognizable and, on the other hand, automatically extractable in a simple manner. This can be achieved, for example, by particularly easily recognizable features, for example edges, corners, contrast differences.

It is particularly favorable in this case if the data processor is configured for comparing a main item of identification information to a checking item of identification information of an item of identification information, in particular the above-mentioned item of identification information. It is advantageous in this case that the item of identification information can be read out automatically and is checkable for readout errors, which can be produced, for example, by a partially concealed item of identification information.

In one embodiment of the invention, it can be provided that a temperature sensor is formed, and the data processor is configured at least for a temperature compensation of an item of scaling information ascertained from at least one recorded image on the basis of a temperature measured value of the temperature sensor. It is advantageous in this case that the use of temperature-stabilized materials can be omitted for the photogrammetric panel. For example, it can be provided that the temperature sensor is formed on the photogrammetric panel. It is advantageous in this case that a temperature of the photogrammetric panel, which permits the ascertainment of an actual expansion of the photogrammetric panel and thus the group of markings printed thereon, is enabled. The temperature compensation is preferably configured in such a manner that heat from the photogrammetric panel is compensated for. Such a temperature compensation enables the accuracy of the extraction of an item of scaling information from the recorded photogrammetric panel to be significantly enhanced.

In one embodiment of the invention, it can be provided that an image recording device is designed, by which the image is recordable. It is advantageous in this case that a compact arrangement can be formed, which can be easily transportable. For example, it can be provided that the image recording device and the data processor are integrated into a handheld device. It is particularly favorable in this case if a temperature sensor, for example the above-mentioned temperature sensor, is formed on the image recording device. It is advantageous in this case that a transfer of the temperature measured values to the data processor is easily implementable.

The features of the independent claim directed to a photogrammetry method are provided according to the invention for achieving the mentioned object in a photogrammetry method. Therefore, it is provided in particular according to the invention, to achieve the mentioned object in a photogrammetry method of the type described at the outset, that the markings are printed on a material, in particular metal plate, and an item of scaling information with respect to the at least one recorded image is ascertained from the markings. It is advantageous in this case that both the coordinate system and also the scaling information are obtainable using a measuring aid, the above-mentioned photogrammetric panel. The apparatus complexity for carrying out the photogrammetry method can thus be substantially reduced. It is particularly favorable if the photogrammetric panel is designed according to the invention, in particular as described above and/or as claimed in any one of the claims directed to a photogrammetric panel, and/or if the photogrammetric panel is designed part of a photogrammetry arrangement according to the invention, in particular as described above and/or as claimed in any one of the claims directed to a photogrammetry arrangement. The advantages of the photogrammetric panel according to the invention and/or the photogrammetry arrangement according to the invention are thus usable in the photogrammetry method according to the invention.

In one embodiment of the invention, it can be provided that for an automatic computation of 3D data from the at least one recorded image (or the recorded images, respectively), a distance of at least two markings from one another in one group of the at least two groups of markings is weighted more strongly than a relative position of at least two markings from different groups. It is advantageous in this case that a relative alignment of the groups to one another has to be carried out with a lower accuracy than the alignment of the markings within a group. Therefore, for example, an angle between the groups of markings and/or an offset of the two groups of markings to one another, which result(s) from the manufacturing tolerances of the printing method, can be produced with greater imprecision without the accuracy of the item of scaling information suffering. It is particularly favorable if a distance of at least two markings from one another in an extension direction, which is predefined by a printing direction, of one group of the at least two groups of markings is weighted more strongly than the above-mentioned relative position of at least two markings from different groups. A high accuracy, which is provided, for example, by precision printing methods in the printing direction, is thus usable to achieve a good accuracy for the item of scaling information.

In one embodiment of the invention, it can be provided that an error message is generated if a predetermined minimum number of markings in one group of the at least two groups is not identifiable or is not identified in at least one recorded image. It is advantageous in this case that it can be displayed to the user when the desired item of scaling information is no longer ascertainable with the desired accuracy.

In one embodiment of the invention, it can be provided that the item of scaling information is temperature-compensated using a temperature measured value. It is advantageous in this case that a change of a size of a photogrammetric panel which bears the markings as a result of temperature changes can be compensated for. It is therefore particularly favorable if the temperature compensation results in a compensation of a thermal expansion of the photogrammetric panel.

In one embodiment of the invention, it can be provided that a photogrammetry arrangement according to the invention, in particular as described above and/or as claimed in any one of the claims directed to a photogrammetry arrangement, is used. A simple implementation of a photogrammetry method according to the invention is thus described.

The invention will now be described in more detail on the basis of an exemplary embodiment but is not restricted to this exemplary embodiment. Further exemplary embodiments result from compensation of the features of individual or multiple claims with one another and/or with individual or multiple features of the exemplary embodiment.

In the figures:

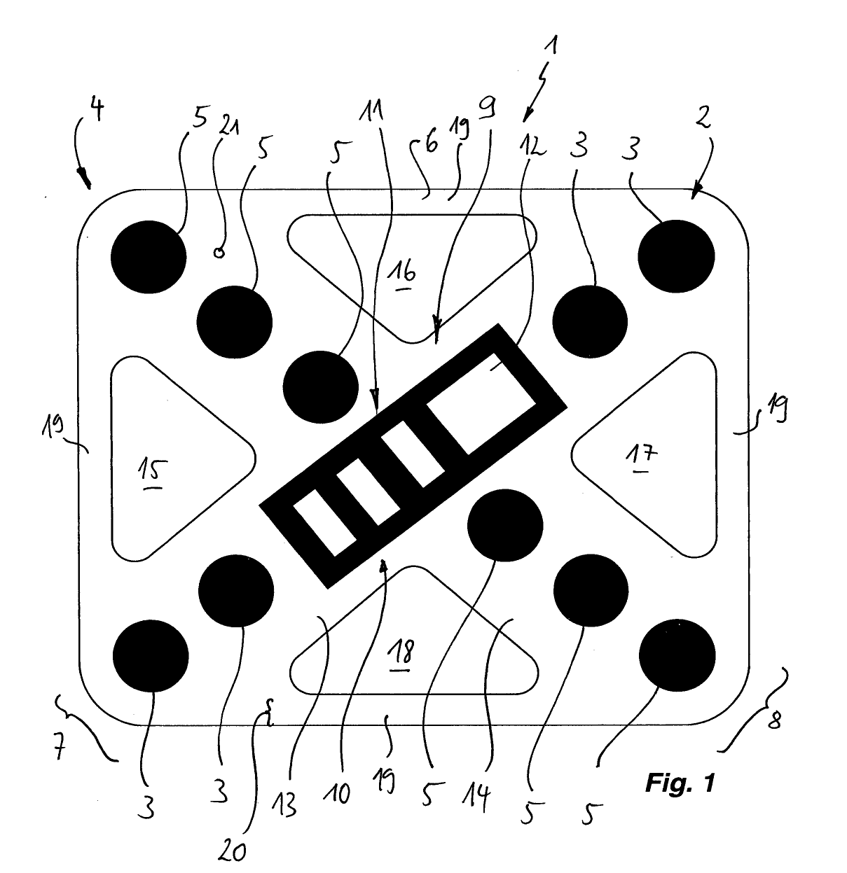

FIG. 1 shows a photogrammetric panel according to the invention in a schematic illustration,

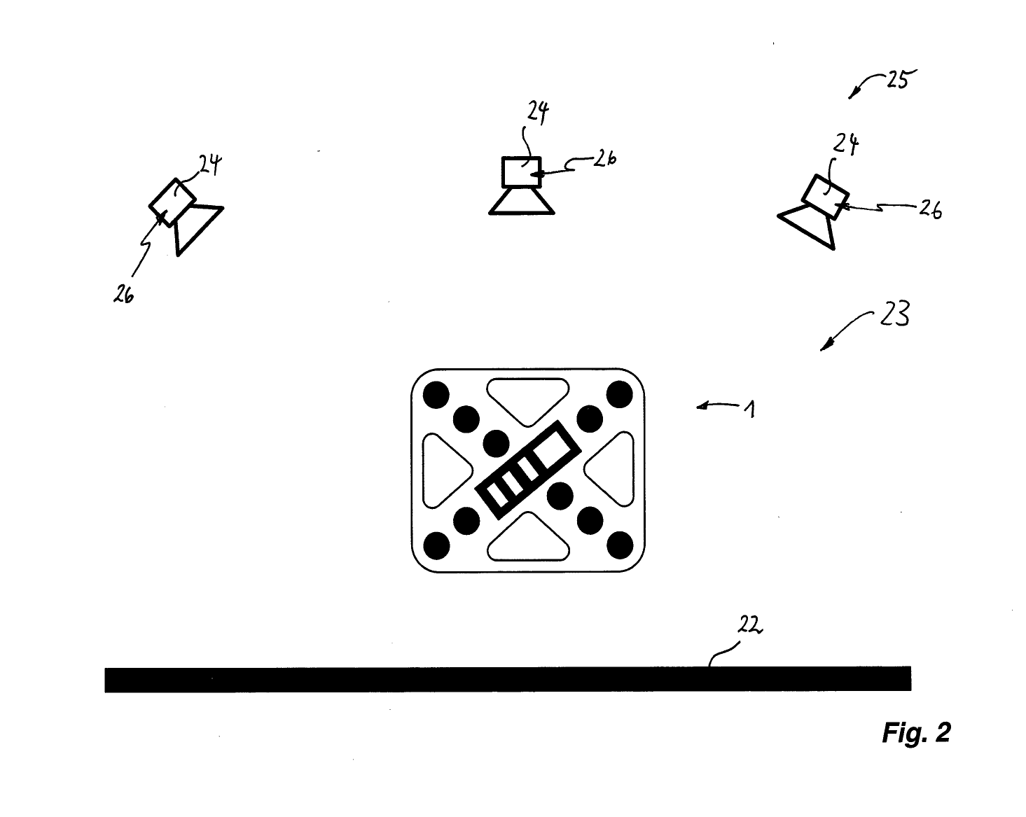

FIG. 2 shows a typical application scenario in a top view of a photogrammetric panel according to the invention in a photogrammetry method according to the invention, and

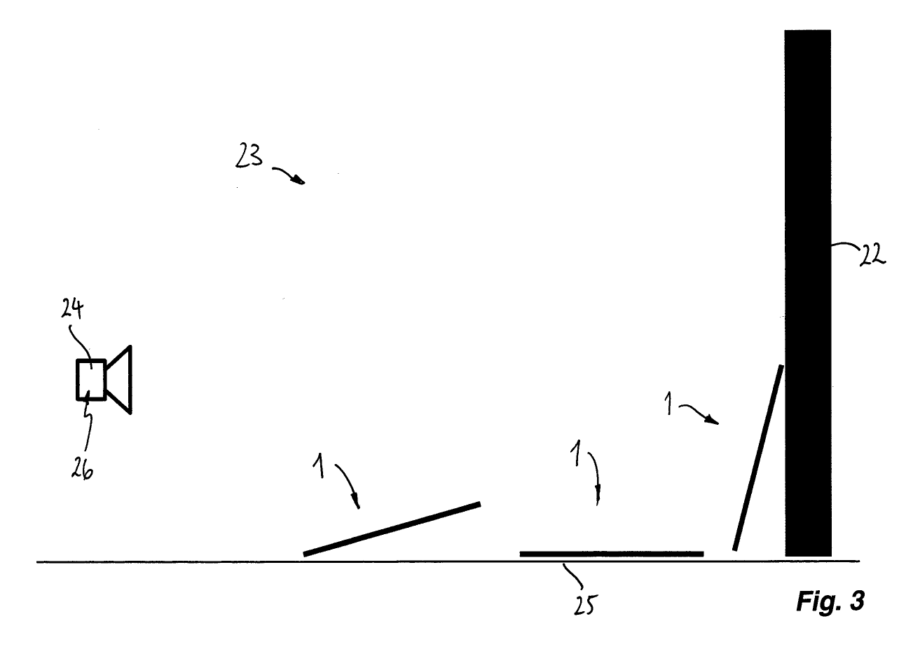

FIG. 3 shows an application scenario in a side view of a photogrammetric panel according to the invention in a photogrammetry method according to the invention, wherein the photogrammetric panel is arranged in three conceivable positions by way of example.

A photogrammetric panel according to the invention, identified as a whole with 1, has a first group 2 of markings 3 and a second group 4 of markings 5.

The markings 3, 5 are each circular and are identical to one another.

The four markings 3 thus form a linear arrangement of markings in the first group 2, while the five markings 5 represent a linear arrangement of markings in the second group 4. In further exemplary embodiments, other, in particular larger or smaller, numbers of markings 3, 5 are formed.

The markings 3, 5 are printed on a metal plate 6 or another material having a known coefficient of thermal expansion.

In this case, the markings 3 are applied in a first printing web 7 along a diagonal of the rectangular metal plate 6.

The markings 5 are applied in a manner crossing this in a second printing web 8.

The printing webs 7 and 8 are applied in succession in a precision printing method.

Due to the crossed arrangement of the printing webs 7 and 8, the second group 4 of markings 5 lies in a second diagonal of the rectangular basic shape of the metal plate 6.

An item of identification information 10 is formed in a crossing region 9 of the groups 2, 4. The item of identification information 10 is applied with lesser printing accuracy and is applied in a method separate from the mentioned precision printing method.

The item of identification information 10 is divided in this case into a main item of identification information 11 and a checking item of identification information 12, for example a checksum. The checking item of identification information 12 is thus usable to automatically check the correct extraction of the main item of identification information 11.

The printing webs 7, 8 are each occupied in such a manner that they lie on a strip-shaped area 13, 14. The strip-shaped area 13 is therefore arranged crossed with respect to the strip-shaped area 14. The strip-shaped areas 13, 14 are provided in this case in that material openings 15, 16, 17, 18 are formed in unprinted regions.

The material openings 15, 16, 17, 18 not only reduce the intrinsic weight of the photogrammetric panel 1, but rather simultaneously form a handle 19.

An unprinted plug region 20 is formed at the lower end of the photogrammetric panel 1, using which plug region the photogrammetric panel is pluggable into a region of the earth's surface which has soil or another soft material.

In the exemplary embodiment shown, the photogrammetric panel 1 is made of a metal plate 6, of aluminum or of steel.

A temperature sensor 21 is arranged on the photogrammetric panel 1, using which a temperature of the photogrammetric panel 1 is acquirable.

This temperature sensor 21 is connected to a transmitter for the measured value (not shown in greater detail) to transmit the temperature measured value to a data processor 26 (cf. FIGS. 2 and 3).

The data processor 26 is configured for a temperature compensation of an item of scaling information ascertained from at least one recorded image on the basis of the temperature measured value for a compensation of a thermal expansion of the photogrammetric panel 1.

The data processor 26 is in this case a component of a photogrammetry arrangement 25 according to the invention as shown in FIGS. 2 and 3, which, in addition to the photogrammetric panel shown, has the above-mentioned data processor 26, for example in an image recording device 24 or as a separate unit, which data processor is configured for a photogrammetric processing of at least one recorded image.

In this case, the data processor 26 is configured in such a way that a coordinate system can be computed from the location of the markings 3, 5 of the groups 2, 4 in the recorded image and an item of scaling information can be computed from a distance of at least two markings 3, 5 within a common group 2, 4.

Furthermore, an image recording device 24, which is also illustrated by way of example in FIGS. 2 and 3, for example a camera, is formed in the photogrammetry arrangement 25 for recording the image. The image recording device 24 can be provided with a further temperature sensor to compensate for a thermal expansion of the photogrammetric panel 1.

In the photogrammetry method according to the invention, the photogrammetric panel 1 shown in FIG. 1 is therefore arranged in a scene, wherein an image of the scene is recorded using the image recording device 24.

This is shown by way of example in the typical application scenarios according to FIG. 2 (top view) and FIG. 3 (side view).

Accordingly, the photogrammetric panel 1 of a photogrammetry arrangement 25 is positioned close to, in particular in front of, an object 22 of the scene 23. Subsequently, the scene 23 comprising the object 22 and the photogrammetric panel 1 is recorded using an image recording device 24 of the photogrammetry arrangement 25. In this case, positions of the image recording device 24, for example a camera, selected in chronological succession are shown in FIG. 2, from which positions the scene 23 is recorded. In a further exemplary embodiment, setups comprising multiple image recording devices 24 which are each arranged fixed in place or are aligned fixedly in relation to one another, for example so-called multi-camera setups, are provided.

A series of multiple recorded images thus results.

It is apparent in FIG. 3 that the photogrammetric panel 1 can be arranged in various positions in relation to the object 22. The illustration is to be understood solely as an example, and further positions are conceivable and can be assumed. Accordingly, the photogrammetric panel 1 can be arranged, for example, directly in front of the object 22 with a tilt in relation to the image recording device 24. In this case, the photogrammetric panel 1 can be leaned, for example, directly on the object 22 (right-hand position in FIG. 3), can be laid flat on a floor 25 (middle position), or can be set down with a settable angle on the floor (right-hand position in FIG. 3). In the photogrammetry method according to the invention, the mentioned different recordings are carried out using the image recording device 24 such that the relative position of the photogrammetric panel 1 in relation to the scene 23 or at least the object 22 does not change between the individual recordings.

In the recorded image, using a data processor of the photogrammetry arrangement, the two groups 2, 4 of markings 3, 5 are identified and a coordinate system of the recorded image is ascertained from the at least two crossing groups 2, 4 of markings 3, 5. This coordinate system describes the location of the photogrammetric panel 1 in relation to the imaging direction.

Moreover, an item of scaling information, which characterizes an imaging distance from the photogrammetric panel 1, is ascertained from the automatically acquired markings 3, 5. In this case, distances between markings 3 or 5 within the group 2 or 4, respectively, are weighted more strongly than distances between markings 3, 5 which are not part of the same group 2, 4. This takes into consideration that the relative alignment of the group 2 in relation to the group 4 is of lesser accuracy than the arrangement of the markings 3, 5 within their own group 2, 4 is producible.

It can sometimes occur during the recording of the image that individual markings 3, 5 are entirely or partially concealed, and therefore they are no longer automatically identifiable. In this case, the data processor outputs an error message if a predetermined minimum number of markings 3, 5 in one of the two groups 2, 4 or both groups 2, 4 is jointly no longer identifiable. The user recognizes from this that he has to check and possibly change the positioning of the photogrammetric panel 1 in order to obtain a usable recording of an image.

During the recording of the image, the temperature sensor 21 transmits a temperature measured value from the photogrammetric panel 1 to the above-mentioned data processor. The actual distance of the markings 3 within the group 2 from one another or the actual distance of the markings 5 of the group 4 from one another is computed from this temperature measured value in the data processor, and therefore a thermal expansion of the photogrammetric panel 1 is compensated for. Subsequently, an item of temperature-compensated scaling information is computed in a manner known per se from these items of temperature-compensated distance information.

In the photogrammetric panel 1 for use in a photogrammetry method, it is therefore provided that at least two groups 2, 4 of markings 3, 5 be printed in a crossed arrangement on a material, in particular on a metal plate 6.

### LIST OF REFERENCE NUMERALS

1 photogrammetric panel
2 first group
3 marking
4 second group
5 marking
6 metal plate
7 first printing web
8 second printing web
9 crossing region
10 item of identification information
11 main item of identification information
12 checking item of identification information
13, 14 strip-shaped area
15, 16, 17, 18 material opening
19 handle
20 plug region
21 temperature sensor
22 object
23 scene
24 image recording device
25 photogrammetry arrangement
26 data processor

1. A photogrammetric panel (1), comprising at least two groups (2, 4) of markings (3, 5), which are in a crossed arrangement in relation to one another, wherein the photogrammetric panel (1) is manufactured from a printed material plate (6).

2. The photogrammetric panel (1) as claimed in claim 1, wherein the at least two groups (2, 4) of markings (3, 5) are at least one of applied in separate printing webs (7, 8), applied using a precision printing method, or the at least two groups (2, 4) of markings (3, 5) are each applied in one diagonal of a rectangular basic shape.

3. The photogrammetric panel (1) as claimed in claim 1, further comprising an item of identification information (10) applied to the plate as a main item of identification information (11) and a checking item of identification information (12), at least one of independently of the at least two groups (2, 4) of markings (3, 5) or in a crossing region (9) of the at least two groups (2, 4) of markings (3, 5).

4. The photogrammetric panel (1) as claimed in claim 1, further comprising a strip-shaped area (13, 14) of the plate, on which one of the at least two groups (2, 4) of markings (3, 5) is applied, is defined by material openings (15, 16, 17, 18) in a rectangular basic shape of the plate.

5. The photogrammetric panel (1) as claimed in claim 1, wherein the photogrammetric panel (1) is manufactured from at least one of printed aluminum or steel.

6. A photogrammetry arrangement (25) comprising:
a photogrammetric panel (1) formed with at least two groups (2, 4) of markings (3, 5), which are in a crossed arrangement in relation to one another, wherein the photogrammetric panel (1) is manufactured from a printed material,
a data processor configured for photogrammetric processing of at least one recorded image, the data processor is further configured for ascertainment of a coordinate system of the image from the at least two crossing groups (2, 4) of markings (3, 4) on the photogrammetric panel (1) and for ascertainment of an item of scaling information from the markings (3, 5) on the photogrammetric panel (1) in the image.

7. The photogrammetry arrangement (25) as claimed in claim 6, wherein the data processor (26) is configured for extraction of at least one item of identification information (10), in particular by feature recognition, on the photogrammetric panel (1) in the at least one recorded image, and the data processor (26) is further configured for comparing a main item of identification information (11) to a control item of identification information (12) of the item of identification information (10).

8. The photogrammetry arrangement (25) as claimed in claim 6, further comprising a temperature sensor (21), and the data processor (26) is configured at least for a temperature compensation of the item of scaling information ascertained from at least one recorded image on the basis of a temperature measured value of the temperature sensor (21) for a compensation of a thermal expansion of the photogrammetric panel (1).

9. The photogrammetry arrangement (25) as claimed in claim 6, further comprising an image recording device (24) by which the image is recordable.

10. A photogrammetry method, comprising:
providing a photogrammetric panel (1) with at least two groups (2, 4) of markings (3, 5), including printing the markings (3, 5) on a plate (6),
arranging the a photogrammetric panel (1) with the at least two crossing groups (2, 4) of markings (3, 5) in a scene,
recording at least one image of the scene, and
ascertaining a coordinate system of the at least one recorded image from the at least two crossing groups (2, 4) of markings (3, 5), wherein
an item of scaling information with respect to the at least one recorded image is ascertained from the markings (3, 5).

11. The photogrammetry method as claimed in claim 10, further comprising:
for an automatic computation of 3D data from the at least one recorded image, weighing a distance of at least two of the markings (3, 5) from one another in an extension direction of one group (2, 4) of the at least two groups (2, 4) of markings (3, 5) more strongly than a relative position of at least two of the markings (3, 5) from a different group (2, 4).

12. The photogrammetry method as claimed in claim 10, further comprising:
generating an error message if a predetermined minimum number of markings (3, 5) in one group (2, 4) of the at least two groups (2, 4) is not identifiable in the at least one recorded image.

13. The photogrammetry method as claimed in claim 10, further comprising:
temperature-compensating the item of scaling information using a temperature measured value.

14. The photogrammetry method as claimed in claim 13, wherein the temperature compensation is for compensation of a thermal expansion of the photogrammetric panel (1).

15. The photogrammetry arrangement (25) as claimed in claim 9, further comprising a temperature sensor (21) formed on the image recording device (24).
